(19) United States
(12) Patent Application Publication
(10) Pub. No.: US 2022/0219959 A1
(43) Pub. Date: Jul. 14, 2022

(54) Material handling system

(71) Applicant: Brad Stroh, Buckingham, IA (US)

(72) Inventor: Brad Stroh, Buckingham, IA (US)

(21) Appl. No.: 17/144,698

(22) Filed: Jan. 8, 2021

(51) Int. Cl. B66F 9/065; H01F 41/02

(52) U.S. Cl. CPC B66F 9/0655; H01F 41/0206

(57) ABSTRACT

A material handling system for engaging and transporting material. The material handling system includes a mouth and a hydraulic actuator for pivoting a tooth within the mouth. Once a material has been positioned within the mouth, the hydraulic piston actuates the tooth to secure the material within the mouth. The tooth is preferably configured and oriented to move into tighter engagement with the material as gravity or other forces attempt to remove the material from the mouth. The bottom jaw of the mouth tapers to a tip that allows the system to more easily pick up material from a surface and to more easily maneuver the tip into tight spaces. The hydraulic piston allows an operator to release the tooth whenever desired and a check valve provided on the hydraulic piston prevents the system from inadvertently dropping material. The material handling system includes a vehicle mounted boom coupled to the mouth so that material engaged by the mouth may be transported to another desired location.

### BACKGROUND OF THE INVENTION

### 1. Field of the Invention

The present invention relates in general to a material handling system and, more particularly, to a mechanically actuated plate clamp.

### 2. Description of the Prior Art

When recycling large transformers, especially transformers of one megavolt-ampere (MVA) or greater, it is desirable to preserve the metallic laminations from the transformer's core. Due to the unique construction of the laminations, it is desirable to remove the laminations and place them on a transport vehicle with a minimum of damage so that the laminations can be reused or cut as desired to use in smaller transformer applications.

Prior art material handling machines can be used to move laminations. Drawbacks associated with using prior art material handling machines to move laminations include damage to the laminations from gripping too tightly or damage from dropping laminations gripped too loosely. It would, therefore, be desirable to provide a system for removing and handling laminations without damaging them.

It is known in the art to provide a plate clamp for the movement of large flat pieces of material. Prior art plate clamps include two parallel plates divided by a spacer and forming a mouth. A curved tooth is journaled between the plates for movement within the mouth. When a large plate is positioned in the mouth, the tooth moves into contact with the plate. As the plate clamp is moved away from the plate, such as when attempting to lift the plate, the movement of the plate out of the mouth of the plate clamp causes the tooth to pivot into further engagement with the plate.

The curved tooth, therefore, pins the plate between the lower law of the parallel plates and the tooth. Additional movement of the plate in a direction out of the mouth further pinches the plate between the tooth and the lower jaw. In the prior art, the plate clamp is coupled to ropes or cables and lifted upward to move a plate to a desired location. When it is desired to release the plate clamp, the plate clamp is moved toward the plate to move the plate further into the mouth of the plate clamp. As the plate moves further into the mouth of the plate clamp, the pinching pressure between the tooth and lower jaw is released, thereby allowing the tooth to pivot inward, upward and away from the plate. The plate may thereafter be released from the plate clamp.

One drawback associated with the prior art plate clamps is that prior art plate clamps are typically moved with ropes or cables within a warehouse or other interior setting. The use of ropes or cables makes it difficult to utilize prior art plate clamps outdoors, and to accurately control the movement of the plate clamp. Additionally, the use of ropes or cables in association with the plate clamp does not allow for pivoting of the plate clamp to allow the plate clamp to angle the plate upward as it is being moved.

An additional drawback associated with prior art plate clamps is that prior art plate clamps cannot be moved toward the plate without risking a loss of pressure on the plate and disengagement of the plate from the plate clamp. Similarly, the prior art plate clamp cannot be inverted, as gravity would force the plate into the mouth of the plate clamp, thereby releasing the pressure on the plate and allowing the plate to dislodge from the mouth of the plate clamp.

Still another problem associated with prior art plate clamps is the shallowness of the mouth associated with such clamps. It would be desirable to provide a plate clamp with a deeper mouth, allowing for securement of a wider range of materials within the mouth of the plate clamp. Yet another drawback associated with the prior art is the inability to easily disengage the plate clamp from a plate while the plate is raised. It would, therefore, be desirable to provide a material handling system which could be remotely actuated to secure a plate or other large piece of material and to move that piece of material to another position before release. It would also be desirable to provide such a material handling system with a deep mouth and secure mechanical engagement of a plate between a tooth and a lower jaw. It would be desirable to provide such a device the ability to secure the material even when the material handling system is moved toward the material, or the material is being forced by gravity deeper into the mouth of the material handling system.

It would be desirable to provide a material handling system which could be released from the material even when the material is being suspended downward and gravity is acting on the material in a direction outward from the mouth of the material handling system. It would also be desirable to provide such a material handling system on a vehicle mounted boom or other system for utilizing the material handling system outdoors and to position the material handling system at a plurality of heights and orientations as desired to move material.

In material handling situations, such as removing laminations from used electric transformers, prior art plate clamps are not maneuverable enough or precise enough to accurately and safely remove the sharp laminations from a transformer. Accordingly, this process must be accomplished by hand, exposing workers to dangerously sharp metal edges. It would, therefore, be desirable to provide a material handing system which could remotely handle hazardous materials, such as sharp edged metal plates, remotely with a smaller number of workers.

A material handler substantially eliminating the foregoing difficulties is described in U.S. Pat. No. 7,967,548, which is incorporated herein by reference. A disadvantage of such systems is that the height of the lower jaw can make it difficult to pick up objects from a surface or from a narrow area. It would be desirable to provide a material handler with an increased ability to retrieve objects from a surface and from narrow areas. Another disadvantage of such systems is that if the material handler were to sustain damage or a malfunction while transporting a load, the material handler could release the load, possibly causing a safety issue. It would be desirable to provide a material handler that retains a load in the event the material handler sustains damage or a malfunction. The difficulties encountered in the prior art discussed hereinabove are substantially eliminated by the present invention, proving a safer more maneuverable and usable material handling system.

### SUMMARY OF THE INVENTION

In an advantage provided by this invention, a material handling system is provided which may be utilized to actively engage and move material.

Advantageously, this invention provides a material handling system which may be actuated to engage when the material handling system moves toward the material.

Advantageously, this invention provides a material handling system which may be actuated to release when the material is being drawn away from the material handling system.

Advantageously, this invention provides a material handling system which can engage material in a plurality of orientations.

Advantageously, this invention provides a material handling system which may be remotely actuated.

Advantageously, this invention provides a material handling system which may be mounted on a boom provided on a vehicle.

Advantageously, this invention provides a material handling system which safely handles hazardously sharp materials.

Advantageously, this invention provides a material handling system which reduces the number of workers to handle a particular material.

Advantageously, this invention provides a material handling system which can easily pick up items from a flat surface.

Advantageously, this invention provides a material handling system which can more easily maneuver in tight spaces.

Advantageously, this invention provides a material handling system which can retain material being transported when the system sustains damage or malfunction.

Advantageously, in a preferred example of this invention, a material handling system is provided with an upper jaw and a lower jaw defining an opening. A tooth is provided on the opening, as are means coupled to the tooth for moving the tooth within the opening. In the preferred embodiment, the tooth is coupled to a linear actuator which presses the tooth against material provided in the opening to retain the material between the tooth and the lower jaw. The lower jaw is tapered. The material handling system is provided with a check valve to retain the linear actuator is a predetermined position. The material handling system is coupled to a boom mounted on a vehicle to allow the material handling system to be oriented in any one of a plurality of desired orientations, and to move material from one location to another location.

### BRIEF DESCRIPTION OF THE DRAWINGS

The present invention will now be described, by way of example, with reference to the accompanying drawings in which:

FIG. 1 illustrates a front perspective view of the material handling system of the present invention;

FIG. 2 illustrates a rear perspective view of the material handling system of the present invention;

FIG. 3 illustrates a top elevation in partial phantom of the material handling system of the present invention shown with the hydraulic cylinder removed;

FIG. 4 illustrates a side elevation in partial phantom of the material handling system of the present invention shown with the hydraulic cylinder removed;

FIG. 5 illustrates a front perspective view of the material handling system of the present invention shown with the hydraulic cylinder removed;

FIG. 6 illustrates a front perspective view of the material handling system of the present invention engaged with and moving laminations from a transformer;

FIG. 7 illustrates a rear perspective view of the material handling system of the present invention loading laminations into a transport vehicle; and

FIG. 8 illustrates a front elevation of the material handling system engaged with and moving bulk materials.

### DETAILED DESCRIPTION OF THE PREFERRED EMBODIMENTS

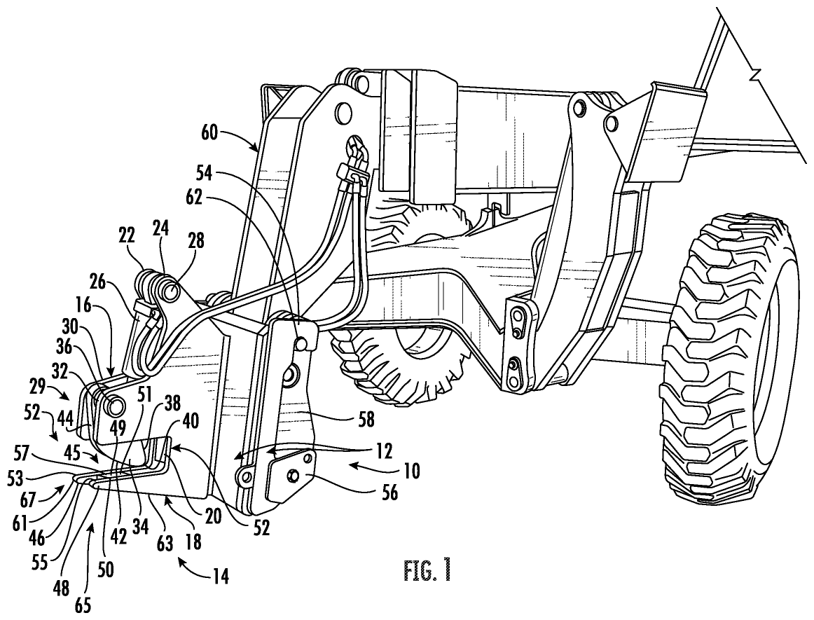

A material handling system according to this invention is shown generally as (10) in FIG. 1. As shown in FIGS. 1-5, a base (12) is coupled to a material handler (14). The material handler (14) includes a first side plate (16) and second side plate (18) welded to the base (12). Provided between the first side plate (16) and second side plate (18) is a spacer (20). The first side plate (16) and second side plate (18) define a first piston tab (22) and second piston tab (24). Provided between the first piston tab (22) and second piston tab (24) is a linear actuator, such as a hydraulic piston (26) journaled therein by a pin (28) secured to the first piston tab (22) and second piston tab (24). Alternatively, a pneumatic piston on a worm gear system (not shown) may be utilized in place of the hydraulic piston (26). The first side plate (16) and second side plate (18) also define an upper jaw (29) having a first upper jaw plate (30) and second upper jaw plate (32).

Journaled at a journal point between the first upper jaw plate (30) and second upper jaw plate (32) is a tooth (34) journaled therein by a pin (36).

As shown by FIGS. 1-5, the tooth (34) includes a non-contact face in the form of a straight back portion (38) extending to a rounded tooth tip (40), then extending across a material handling contact face in the form of a curved front (42). The tooth (34) also includes a flat top (44) connecting the curved front (42) to the straight back (38). While the tooth (34) may be of any desired configuration, at least a portion of the tooth (34) facing a lower jaw (45) is curved to provide the tooth (34) with a camming effect, and to allow the tooth (34) to engage material of varying thickness. The hydraulic piston (26) is provided between the first side plate (16) and the second side plate (18) and between the tip (40) of the tooth (34) and the pin (28).

The lower jaw (45) includes a first lower jaw (46) and second lower jaw (48) defined by the first side plate (16) and second side plate (18). Welded between the first lower jaw (46) and second lower jaw (48) is a steel plate (50) forming a top face (49) of the lower jaw (45). The top face (49) of the steel plate (50) is provided with a rough surface (51) to facilitate the retention of material against the top face (49) of the steel plate (50). The rough surface (51) can be constructed of weldments, abrasive material, teeth, or any other type of retention system known in the art. Along with the steel plate (50), the top (53) of the first lower jaw (46) and the top (55) of the second lower jaw (48) form a top face (57) of a lower jaw (45).

A bottom (61) of first lower jaw (46) and a bottom (63) of the second lower jaw (48) form a bottom face (65) of the lower jaw (45). The bottom face (65) of the lower jaw (45) is preferably substantially perpendicular to the base (12) of the material handler (14). As shown in FIGS. 1-5, the bottom face (65) of the lower jaw (45) and the top face (57) of the lower jaw (45) taper toward one another to form a jaw tip (67). The jaw tip (67) can be any desired height, but in a preferred embodiment is 5 millimeters to 80 millimeters, more preferably 10 millimeters to 50 millimeters, and most preferably about 25 millimeters. In a preferred embodiment, downward and forward angle of the top face (57) of the lower jaw (45) causes the top face (57) to taper toward the bottom face (65) of the lower jaw (45) at an angle between 3 and 45 degrees, more preferably at an angle between 5 and 35 degrees, and most preferably at an angle of about 25 degrees. If desired the angle of the taper may vary from the rear (69) of the lower jaw (45) to the jaw tip (67). A bottom (71) of the first upper jaw plate (30) and a bottom (73) of the second upper jaw plate (32) form a bottom face (75) of the upper jaw (45). The bottom face (75) of the upper jaw (45) is preferably substantially parallel with the top face (57) of a lower jaw (59).

The configuration of the taper and the jaw tip (67) may be adjusted to provide the lower jaw (46) with more taper and/or a taller jaw tip (67) to provide more strength or to provide the lower jaw (46) with more less and/or a shorter jaw tip (67) to allow the lower jaw (45) to more easily pick up items off of a surface or to be inserted into smaller areas.

The first upper jaw plate (30), second upper jaw plate (32) and first lower jaw (46) and second lower jaw (48) define an interior having a forward and downward facing opening such as a mouth (52). While the mouth (52) may be of any desired height, in the preferred embodiment, the mouth (52) is at least ten centimeters high, more preferably at least thirty centimeters high and, most preferably at least forty-seven centimeters high. While the mouth (52) may be of any desired depth, the mouth (52) is preferably deeper than its height between the first upper jaw plate (30) and first lower jaw (46), more preferably at least twice as deep as its height and, most preferably, at least three times as deep as its height.

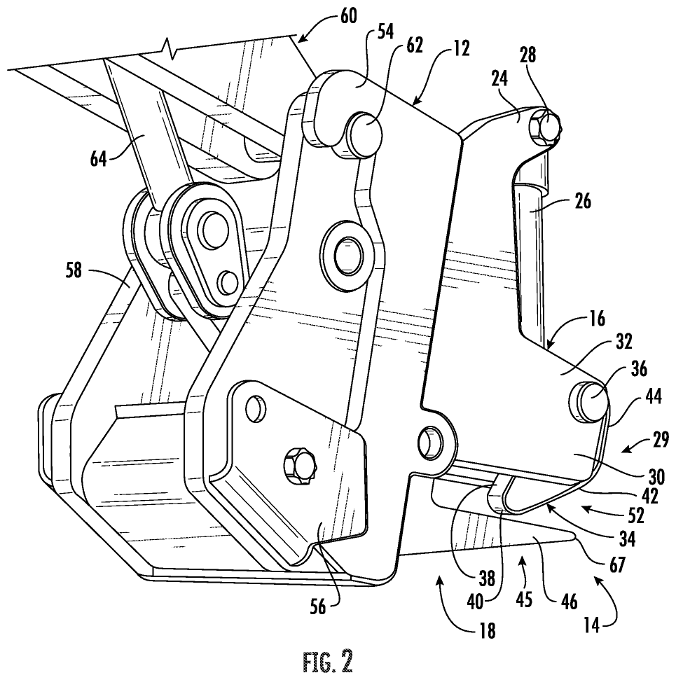

As shown in FIG. 2, the base (12) is provided with a pair of hooks (54) and a lock (56) to engage the base (12) with head (58) of a boom (60), such as that known in the art. As shown in FIG. 2, the set of hooks (54) engage over a set of pins (62) provided on the head (58) of the boom (60) in a manner such as that known in the art for engagement with a plurality of standard implements. The lock (56) engages and secures the head (58) to prevent inadvertent dislodgement of the base (12) from the head (58) of the boom (60). As shown in FIG. 2, a linear actuator, such as a hydraulic piston (64) is secured between the boom (60) and head (58) to allow mechanical pivoting of the head (58) relative to the boom (60).

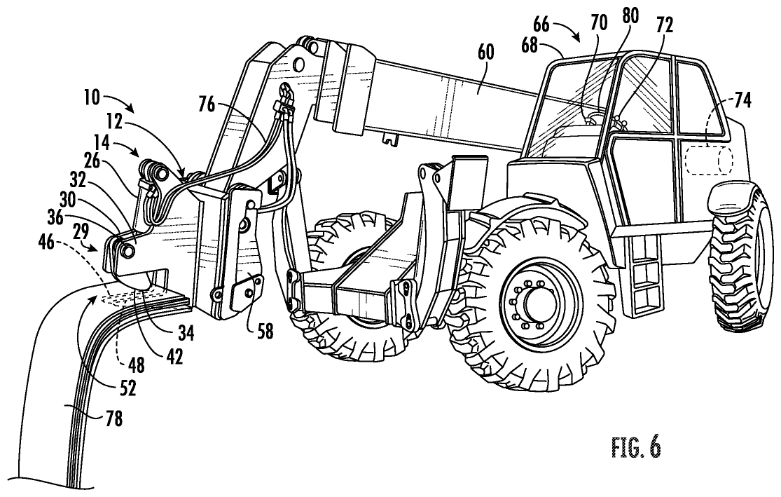

As shown in FIG. 6, the boom (60) is secured to a vehicle (66). The vehicle (66) is provided with a cab (68) within which is provided a joystick (70). In addition to the standard controls (72), such as those known in the art for controlling the boom (60) and head (58), the joystick (70) is coupled to a prime mover such as a linear actuator motor (74), such as a hydraulic pump, coupled to a hydraulic line (76) which, in turn, are coupled to the hydraulic piston (26). Accordingly, movement of the joystick (70) causes the hydraulic piston (26) to move the tooth (34) within the mouth (52) of the material handler (14).

When it is desired to recycle laminations (78), a transformer (79) is dismantled enough to expose the laminations (FIG. 6). In the preferred embodiment, the transformer is at least 1 MVA and the laminations (78) weigh at least one hundred kilograms, and more preferably, at least two hundred fifty kilograms, but the material handling system (10) may be used to recycle laminations (78) of any desired weight from any desired size transformer (79).

Once the laminations (78) have been exposed, the operator actuates the controls (72) to move the boom (60) and head (58) into the desired position, and to position the mouth (52) of the material handler (14) around the laminations (78). The taper of the top face (57) of the lower jaw (45) toward the bottom face (65) of the lower jaw (45) and the low height of the jaw tip (67) allow the jaw tip (67) to be more easily manipulated to pick the laminations off the ground or other surface, or to insert the jaw tip (67) into the transformer (79) or other confined area to extract the laminations (78) or other material.

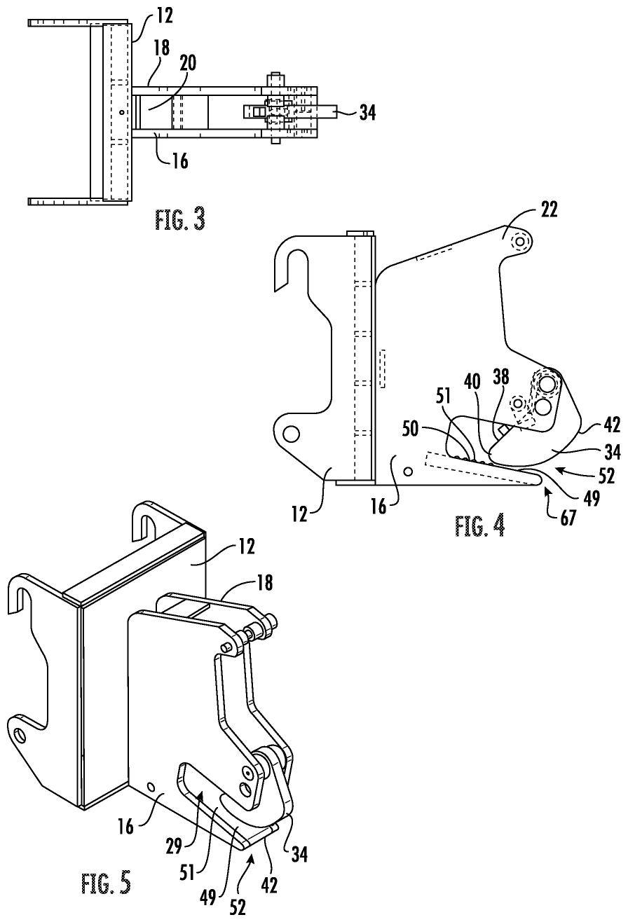

Thereafter, the operator actuates the joystick (70) to cause the hydraulic piston (26) to rotate the tooth (34) to engage the laminations (78) between the curved front (42) of the tooth (34) and the lower jaws (46) and (48). The rough surface (51) of the top face (49) of the steel plate (50) facilitates the retention of the laminations (78) against the top face (51) of the steel plate (50) and impedes the ability of the laminations (78) to become inadvertently dislodged from the material handler (14). If desired, the curved front (42) of the tooth (34) may also be provided with a rough surface (not shown) to facilitate the retention of the laminations (78) against the curved front (42) of the tooth (34). As shown in FIG. 6, it is desirable to configure the tooth (34) so that the tooth tip (40) and the portion of the tooth (34) engaging the laminations (78) are located rearward of the pin (36) securing the tooth (34) to the first upper jaw plate (30) and second upper jaw plate (32). Accordingly, gravity or other force tending to pull the laminations from the mouth (52) of the material handler (14) simply pulls the tooth (34) into tighter engagement with the laminations (78). After the laminations (78) have been engaged, the operator utilizes the vehicle controls (80) to move the vehicle (66) and laminations (78) to a transport vehicle (81). (FIGS. 3-4). It is desirable to remove the laminations (78) from the transformer (79) and insert them into the transport vehicle (81) with a minimum of damage to the laminations (78).

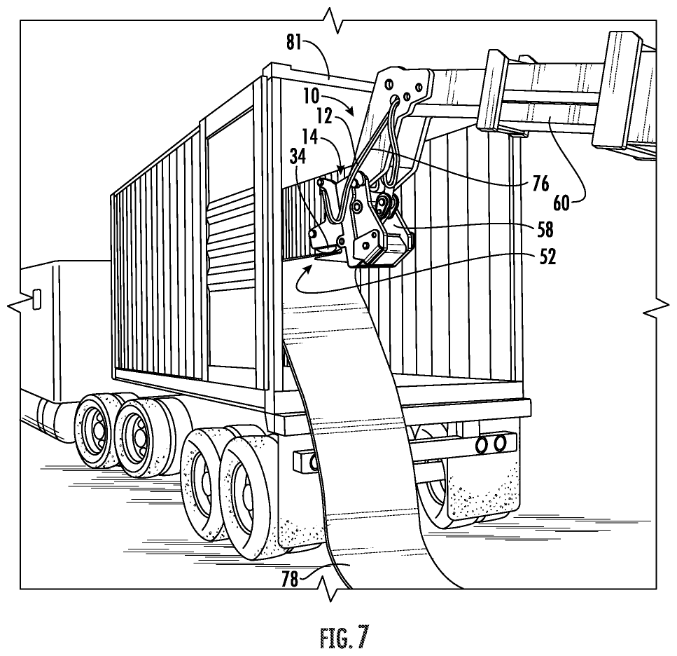

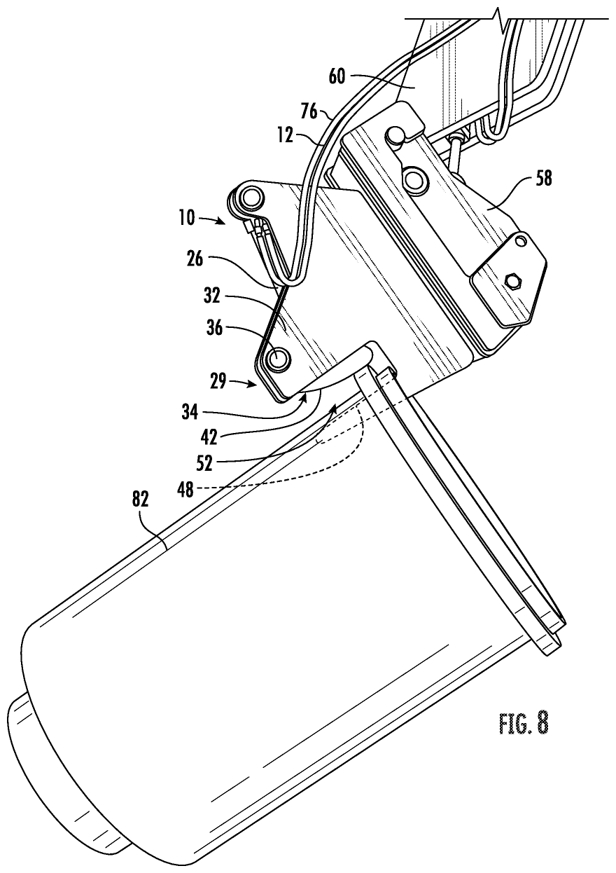

Thereafter, the operator utilizes the controls (72) to position the boom (60) and head (58) in the desired position for release of the laminations (78). (FIGS. 1, 6, and 7). The operator actuates the joystick (70) to release the laminations (78) onto the transport vehicle (81). By providing the material handler (14) with a deep mouth (52) and a hydraulic piston (26), very heavy laminations (78) may be securely engaged by the material handler (14) and safely moved without the dangers associated with manual contact with the sharp metal edges of the laminations (78), and without additional workers required for manual handling and transport of the laminations (78) in accordance with the processes of the prior art.

As shown in FIG. 8, if it is desirable to move larger or bulkier materials or to dump containers, such as a breaker barrel (82), the operator utilizes the vehicle controls (80) to move the vehicle (66) into position near the breaker barrel (82) and then utilizes the controls (72) to position the boom (60) and head (58) so that a portion of the breaker barrel (82) is positioned within the mouth (52) of the material handler (14). Thereafter, the operator actuates the joystick (70) to cause the hydraulic piston (26) to clamp the tooth (34) into engagement with the breaker barrel (82) against the first lower jaw (46) and second lower jaw (48). Although the portion of the breaker barrel (82) gripped by the material handler (14) is much thicker than the laminations (78) discussed above, the curved front (42) of the tooth (34) allows the material handler (14) to securely grip the breaker barrel (82) in a similar manner.

After the breaker barrel (82) has been secured by the material handler (14), the operator actuates the controls (72) to lift the boom (60) and head (58) as desired for transport of the breaker barrel (82). Thereafter, the operator may operate the vehicle controls (80) to move the breaker barrel (82) to another desired location, whereafter the operator may utilize the controls (72) and joystick (70) to dump the breaker barrel (82) before returning it. As shown in FIG. 8, the active engagement of the tooth (34) by the hydraulic piston (26) allows the material handler to release the breaker barrel (82) even when gravity is acting on the breaker barrel (82) to pull the tooth (34) into tighter engagement with the breaker barrel (82). Similarly, even when the breaker barrel (82) is being forced further into the mouth (52) of the material handler (14), such as would be the case if the operator were to actuate the controls (72) to lift the breaker barrel (82) above the mouth (52) of the material handler (14), the operator may use the joystick (70) to actuate the hydraulic piston (26) to cause the tooth (34) to maintain secure engagement with the breaker barrel (82).

The foregoing description and drawings merely describe and illustrate the invention, and the invention is not limited thereto, except insofar as the claims are so limited, that those skilled in the art that have the disclosure before them will be able to make modifications and variations therein without departing from the scope of the invention. For example, the material handling system (10) may be used to transport any desired material and may be constructed of any suitable material in any suitable dimensions, and any suitable configuration. The mouth (52) may be defined by a solid piece of metal rather than a first side plate (16) and second side plate (18) if desired. Additionally, a supplemental tooth may be secured to the first lower jaw (46) and second lower jaw (48) to provide a dual tooth engagement with material provided within the mouth (52) of the material handler (14). Additionally, it is contemplated that the material handler (14) may be utilized in association with cables or ropes, or any other suitable means for moving the material handler (14) into and out of engagement with material.

What is claimed is:

1. A material handling system comprising:
(a) an upper jaw;
(b) a lower jaw coupled to the upper jaw, wherein the upper jaw and the lower jaw define an interior having a forward-facing opening;
(c) wherein the lower jaw comprises:
(i) a top face;
(ii) a bottom face; and
(iii) wherein the top face and the bottom face taper toward one another to form a jaw tip;
(d) a tooth coupled to the upper jaw at a journal point, the tooth comprising:
(i) a material handling contact face;
(ii) a non-contact face; and
(iii) a tooth tip;
(e) a linear actuator coupled to the tooth in a configuration where the tooth tip is located rearward of the journal point, and
(f) a linear actuator motor coupled to the linear actuator.

2. The material handling system of claim 1, wherein the upper jaw comprises a first plate and a second plate and wherein the tooth is provided between the first plate and the second plate.

3. The material handling system of claim 2, wherein the lower jaw comprises a portion of the first plate and a portion of the second plate and wherein the linear actuator is located between the first plate and the second plate.

4. The material handling system of claim 1, further comprising a boom coupled to the upper jaw.

5. The material handling system of claim 4, further comprising a vehicle coupled to the boom.

6. The material handling system of claim 1, wherein the upper jaw comprises a lower face and wherein the lower face of the upper jaw is substantially parallel to the top face of the lower jaw.

7. The material handling system of claim 1, further comprising a vehicle attachment bracket coupled to the upper jaw and to the lower jaw, and wherein the top face of the lower jaw slopes downward and away from the vehicle attachment bracket.

8. The material handling system of claim 7, wherein the bottom face of the lower jaw is substantially perpendicular to the vehicle attachment bracket.

9. The material handling system of claim 1, further comprising a check valve coupled to the linear actuator.

10. The material handling system of claim 1, wherein the jaw tip is less than six centimeters tall.

11. The material handling system of claim 1, wherein the top face and the bottom face taper define an angle between five and forty degrees.

12. A material handling system comprising:
(a) a boom;
(b) an upper jaw coupled to the boom;
(c) a first linear actuator coupled to the boom and the upper jaw;
(d) a lower jaw coupled to the upper jaw, wherein the upper jaw and the lower jaw define an opening and wherein the lower jaw tapers to a jaw tip;
(e) a tooth coupled to the upper jaw at a journal point, the tooth comprising:
(i) a material handling contact face;
(ii) a non-contact face; and
(iii) a tooth tip;
(f) a second linear actuator coupled to the tooth in a configuration where the tooth tip is located closer to the boom than the journal point, and
(g) a linear actuator motor coupled to the second linear actuator.

13. The material handling system of claim 12, wherein the upper jaw comprises a lower face, wherein the lower jaw comprises a top face, and wherein the lower face of the upper jaw is substantially parallel to the top face of the lower jaw.

14. The material handling system of claim 13, further comprising a vehicle attachment bracket coupled to the upper jaw and to the lower jaw, and wherein the top face of the lower jaw slopes downward and away from the vehicle attachment bracket.

15. The material handling system of claim 14, wherein the lower jaw further comprises a bottom face, wherein the bottom face of the lower jaw is substantially perpendicular to the vehicle attachment bracket.

16. The material handling system of claim 12, further comprising a check valve coupled to the second linear actuator.

17. A method for removing material from a core of a transformer comprising:
(a) providing a transformer having material contained at least partially therein;
(b) providing a material handling system comprising:
(i) an upper jaw;
(ii) a lower jaw coupled to the upper jaw, wherein the upper jaw and the lower jaw define an interior having a forward-facing opening and wherein the lower jaw tapers to a jaw tip;
(iii) a tooth coupled to the upper jaw at a journal point, the tooth comprising:
a. a material handling contact face;
b. a non-contact face; and
c. a tooth tip;
(iv) a linear actuator coupled to the tooth;
(c) providing at least a portion of the material within the opening; and
(d) actuating the linear actuator to move the tooth until the material is retained between the material handling contact face of the tooth and the lower jaw at a point rearward of the journal point.

18. The method for removing material from a core of a transformer of claim 17, wherein the material is a lamination in excess of one hundred kilograms.

19. The method for removing material from a core of a transformer of claim 17, further comprising a vehicle attachment bracket coupled to the upper jaw and to the lower jaw, wherein the lower jaw further comprises a top face and a bottom face, and wherein the top face of the lower jaw slopes downward and away from the vehicle attachment bracket.

20. The method for removing material from a core of a transformer of claim 17, wherein the upper jaw comprises a lower face, wherein the lower jaw comprises a top face, and wherein the lower face of the upper jaw is substantially parallel to the top face of the lower jaw.
